(19) United States
(12) Patent Application Publication
(10) Pub. No.: US 2004/0012979 A1
(43) Pub. Date: Jan. 22, 2004

(54) Cable systems for transmitting light in lateral directions

(76) Inventor: John B. Squicciarini, Aliso Viejo, CA (US)

Correspondence Address: Diopco, LLC, 42714 Woodward Avenue, Bloomfield Hills, CA, 48304-5061, US

(21) Appl. No.: 10/201,487

(22) Filed: Jul. 22, 2002

(51) Int. Cl. F21V 7/04

(52) U.S. Cl. 362/555

(57) ABSTRACT

A light transmitting cable provides a flexible and highly efficient conductor for moving light energy with low loss. One end of the conductor is enabled for efficiently accepting the light energy. A sheath is tight fitted around the cable for protection against abrasion. A plurality of spaced apart light emitters are formed integrally with the cable and are enabled for directing portions of the light energy laterally from the cable. The light emitters may be caps or other plugs made of light transmissive material, or may be merely apertures in the sheath that are filled with an optical resin. The cable may be used with plural LED light emitters of different wavelength light output to provide color changes in the emitted light.

### BACKGROUND OF THE INVENTION

INCORPORATION BY REFERENCE: Applicant(s) hereby incorporate herein by reference, any and all U.S. patents, U.S. patent applications, and other documents and printed matter cited or referred to in this application.

1. Field of the Invention

This invention relates generally to lighting systems and more particularly to specialty cables having lateral light transmitting capabilities.

2. Description of Related Art

The following art defines the present state of this field:

Dealey, U.S. publication 20020003706, teaches a lighting system for preferentially illuminating the seating area of a mass-transit vehicle and includes a light fixture with a lamp housing longitudinally disposed above the seating area.

Tufte, U.S. publication 20020030997, teaches a lighting apparatus for illuminating side surfaces of objects or equipment such as vehicles, store shelving bars, desks, counters, etc.

Lowry, U.S. publication 20020031316, teaches a fiber optic display apparatus having a plurality of optical fibers conveying a projected image from in input surface to an enlarged display.

Easley, U.S. publication 20020028041, teaches a diffusing optical fiber tip for producing a homogeneous output pattern.

Zarian, U.S. publication 20020028042, teaches a fiber conduit comprising an optical fiber core surrounded by a cladding with a reflective material attached adjacent to or in contact with the cladding and a plurality of illuminators that are formed by uniform cuts in the optical fiber core.

Zarian, U.S. publication 20020025132, teaches a fiber optic conduit including a light transmitting core cladded with a fluoropolymer cladding and a polymeric finish jacket. A light diverting layer is inserted between the cladding and the jacket

The prior art teaches lighting systems for mass-transit vehicles, lighting apparatus for illuminating side surfaces, side lighting optical conduits, fiber optic display apparatus, wide angle light diffusing optical fiber tips, and a linear light form with light diverting layer, but does not teach apparatus for conducting light in a selected direction with means for diverting this light in an orthogonal direction in a sequence of light outputs. The present invention fulfills these needs and provides further related advantages as described in the following summary.

### SUMMARY OF THE INVENTION

The present invention teaches certain benefits in construction and use which give rise to the objectives described below.

It is desirable to provide illumination in the form of a continuous elongated light emitter or a string of emitters to outline objects, identify walkways, define hazards and similar applications. Current solutions include the devices defined by James R. Zarian in the above sited U.S. publications. However, the Zarian devices provide continuous light emission so that the total energy input must be relatively large for a significant brightness along the cable. In the present approach, energy is conserved by restricting output to only a plurality of discrete points of output. In the manner each point of light may be brighter by orders of magnitude and thus visible from a greater distance. Also, the length of the light transmitting cable may be considerably longer for a given light energy input. In the present invention, low output devices such as LED's are used, so as to conserve energy, require only low temperature rise and low voltage circuits. Yet, the apparatus of the present invention enables relatively longer conductors with excellent distance visibility. The present invention also provides for a highly efficient and low cost means for changing the color of the light emitted from the light cable. The present light transmitting cable provides a flexible and highly efficient conductor for moving light energy with low loss. One or both ends of the conductor are enabled for efficiently accepting the light energy into the conductor. A sheath is tight fitted around the conductor for protection against abrasion and to prevent loss of light through the conductor's sides. A plurality of spaced apart light diverter-emitters are placed integrally with the conductor and are enabled for directing portions of the light energy as points of light, laterally from the conductor. The light emitters may be caps or other plugs made of light transmissive material, or may be merely apertures in the sheath that are filled with an optical grade resin. The cable may be used with plural LED light emitters of different wavelength light output to provide color changes in the emitted light.

A primary objective of the present invention is to provide an apparatus and method of use of such apparatus that provides advantages not taught by the prior art.

Another objective is to provide such an invention capable of providing a string of light emitters for showing a path or outline of an object.

A further objective is to provide such an invention capable of providing color changes to a string of light emitters.

A still further objective is to provide such an invention capable of being armored for application in an abrasive application.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of the preferred embodiment of the invention showing a cable for emitting light from distinct points along the cable;

FIG. 2 is similar to FIG. 1 but showing an armored cable wherein the light is emitted through a metal woven fabric;

FIG. 3 is a partial view taken from within line 3 in FIG. 2 showing plural LED light emitters mounted for directing light energy into an end of the cable;

FIG. 4 is a perspective view of a light diverter of the invention;

FIGS. 5, 6 and 7 are sectional schematic views of cables of the preferred embodiments of the present invention using light diverters that do not extend into a primary light carrier, light diverters that extend into the primary light carrier; and diverters using an optical epoxy filling of apertures in a sheath respectively; and

FIG. 8 is a side elevational view of a motorcycle with the present invention mounted thereon for enabling visibility of the vehicle from the side when in a low light environment.

### DETAILED DESCRIPTION OF THE INVENTION

The above described drawing figures illustrate the invention in at least one of its preferred embodiments, which is further defined in detail in the following description.

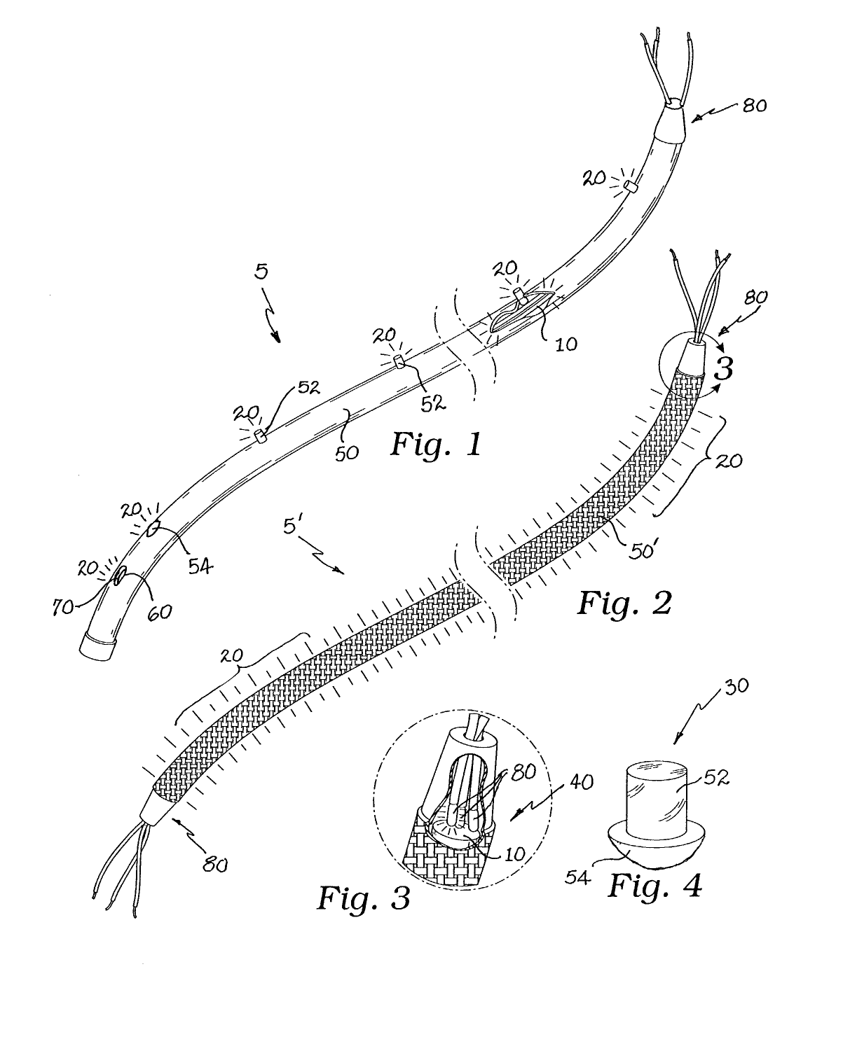

As shown in FIGS. 1 and 2, the present invention is a light transmitting cable apparatus 5 or 5′ comprising one or more elongated and flexible light conductors 10, such as an optical fiber or a bundle of such fibers, or a plastic rod or tube made of polycarbonate resin or other highly transparent and transmissive materials. Such a conductor 10, as is well known, is enabled for moving light energy 20 in a longitudinal direction with low loss. At least one end 40 of the light conductor 10 is enabled, by methods well known in the art, such as polishing, for efficiently accepting the light energy 20 into the light conductor 10. A sheath 50 or 50′ is tight fitted, by for instance, heat shrinking, around the light conductor 10 for protection thereof and this sheath is preferably opaque 50 for preventing light loss. In one embodiment, shown in FIGS. 2 and 3, the sheath is a metal woven fabric being partially open, due to the open nature of the metal weave, to the light energy, so that, in this case, light is emitted at all points on the cable apparatus 5′. Such a sheath 50′ provides improved abrasion resistance. The purpose of the sheath 50, 50′ is primarily mechanical protection of the light conductor 10, as for instance against abrasions and also to prevent general light loss all along the conductor 10. The sheath 50 may be made of plastic heat shrink tubing or other flexible and tight fitting material.

A plurality of spaced apart light emitter-diverters 30, of the types shown in FIG. 1 and FIG. 4, are positioned along the cable apparatus 5. These light emitter-diverters 30 are made of light transmitting materials, and are enabled for diverting portions of the light energy within the light conductor 10 in directions orthogonal to the longitudinal axis thereof, and emitting such diverted light so that it is easily seen from the side of the apparatus 5. In an alternate embodiment, a plurality of spaced apart apertures 60 in the sheath 50, as best shown in FIG. 7, enable portions of the light energy 20 to emerge in lateral directions. Preferably, the apertures are filled with an optical grade epoxy resin 70 to assure physical integrity and to form a light path. In these embodiments, side extraction optical fibers are used preferably.

As shown in FIG. 4, the light emitter-diverters 30, preferably, comprises a plug having a shank 52 and a cap 54. Alternately, the cap 54 may be omitted as is shown in FIG. 1. Preferably, the cap 54 has a convex terminal surface for improved light emission and wide angle dispersion. The cap 54, preferably is positioned to abut the side of the sheath 50.

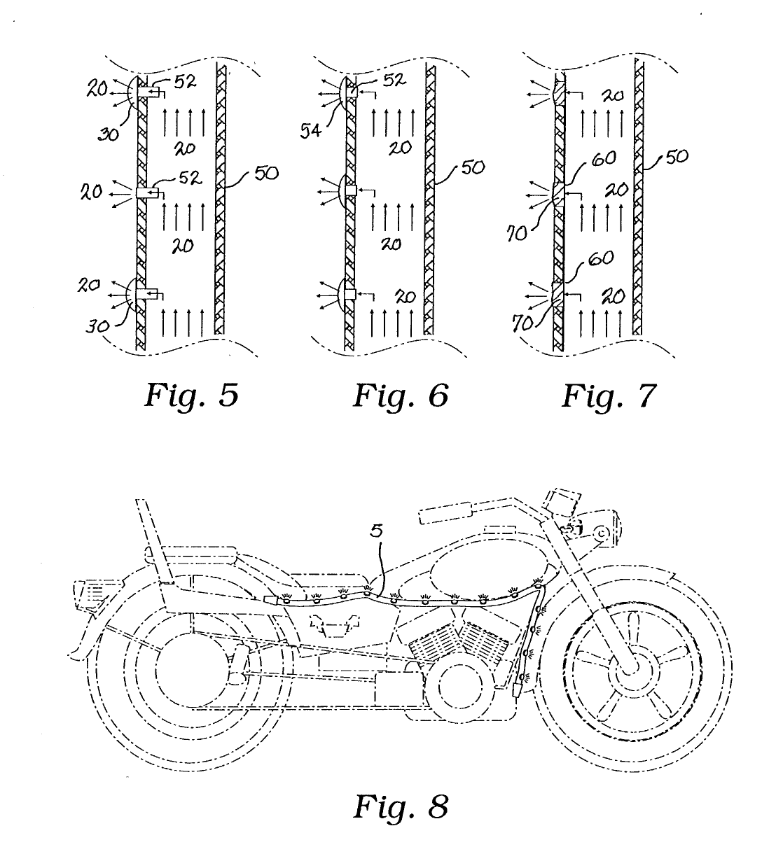

The shank 52, in one embodiment shown in FIG. 6, penetrates the sheath 50 but does not penetrate the light conductor 10. This provides for improved integrity of the conductor 10, but with light transfer efficiency. In the embodiment shown in FIG. 5, the shank 52 does penetrate the light conductor 10, which improves light transfer from the conductor to the shank, but can weaken the conductor 10. In both cases an optical epoxy is used to assure integrity and mechanical strength and low internal light energy loss at the junction of the several surfaces of the shank 52 and the conductor 10.

The present invention further comprises a light source 80, as shown in FIG. 3, positioned for directing light energy into the light emitting means 10 at the at least one end 12. The light source preferably comprises plural light emitting diode (LED) emitters. In the preferred embodiment, a red, blue and green LED, see FIG. 3, are packaged together at the one end 40 of the conductor 10 to provide the possibility of adjustment of color by merely changing the magnitude of current in these LED's. As shown in FIG. 2, the LED's may be placed at both ends of the cable apparatus 5′ so as to improve light energy magnitude.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A light transmitting cable apparatus comprising: an elongated and flexible light conductor enabled for moving light energy longitudinally within the conductor with low loss; at least one end of the light conductor enabled for efficiently accepting the light energy thereinto; a sheath tight fitted around the light conductor for protection thereof; and a plurality of spaced apart light emitter-diverters, integral with the light conductor and enabled for directing portions of the light energy laterally from the conductor.

2. The apparatus of claim 1 wherein the sheath is an opaque tubing.

3. The apparatus of claim 1 wherein the sheath is a metal woven fabric partially transparent to the light energy.

4. The apparatus of claim 1 wherein the light emitter-diverters comprise a plug having a shank and a cap.

5. The apparatus of claim 4 wherein the cap has a convex terminal surface, the cap positioned to abut the sheath.

6. The apparatus of claim 4 wherein the shank penetrates the sheath and does not penetrate the light conductor.

7. The apparatus of claim 4 wherein the shank penetrates the sheath and the light conductor.

8. The apparatus of claim 1 wherein the light emitting means comprises a plug having a shank and no cap.

9. The apparatus of claim 8 wherein the shank penetrates the sheath and does not penetrate the light conductor.

10. The apparatus of claim 8 wherein the shank penetrates the sheath and the light conductor.

11. The apparatus of claim 1 further comprising a light source positioned for directing light energy into the flexible light conductor at the at least one end.

12. The apparatus of claim 111 wherein the light source comprises plural LED emitters.

13. The apparatus of claim 12 wherein the LED emitters comprising 3 emitters emitting red, blue and green light respectively.

14. A light transmitting cable apparatus comprising: an elongated and flexible light conductor enabled for moving light energy longitudinally with low loss; at least one end of the light conductor enabled for efficiently accepting the light energy thereinto; a sheath tight fitted around the light conductor for protection thereof; and a plurality of spaced apart apertures in the sheath for directing portions of the light energy laterally from the conductor; the apertures filled with an optical grade resin.

15. The apparatus of claim 12 further comprising a light source positioned for directing light energy into the light emitting means at the at least one end.

16. The apparatus of claim 14 wherein the light source comprises plural LED emitters.

17. The apparatus of claim 16 wherein the LED emitters comprise 3 emitters emitting red, blue and green light respectively.
